(19) United States
(12) Patent Application Publication
(10) Pub. No.: US 2017/0077723 A1
(43) Pub. Date: Mar. 16, 2017

(54) BATTERY SYSTEM WITH OVERCHARGE AND/OR EXHAUSTIVE-DISCHARGE PROTECTION

(71) Applicant: Lithium Energy and Power GmbH & Co. KG, Stuttgart (DE)

(72) Inventor: Marcel Wilka, Yodogawa (JP)

(21) Appl. No.: 15/258,999

(22) Filed: Sep. 7, 2016

(30) Foreign Application Priority Data
Sep. 10, 2015 (EP) 15184658.1

(51) Int. Cl. H02J 7/00; B60L 11/18

(52) U.S. Cl. CPC H02J 7/0026; B60L 11/18

(57) ABSTRACT

Battery system with overcharge and/or exhaustive-discharge protection, comprising at least one electrical energy store having a first pole which is electrically connected to a first electrode of the electrical energy store, having a second pole which is electrically connected to a second electrode of the electrical energy store, having a rapid-discharge unit for electrically discharging the electrical energy store having a first connection which is electrically connected to the first pole, having a second connection which is electrically connected to the second pole, characterized in that the battery system comprises a tripping unit for tripping the rapid-discharge unit.

### BACKGROUND OF THE INVENTION

The invention proceeds from a battery system with overcharge and/or exhaustive-discharge protection, comprising at least one electrical energy store having a first pole which is electrically connected to a first electrode of the electrical energy store, having a second pole which is electrically connected to a second electrode of the electrical energy store, having a rapid-discharge unit for electrically discharging the electrical energy store having a first connection which is electrically connected to the first pole, and having a second connection which is electrically connected to the second pole according to the preamble of the independent claims.

Document DE 10 2011 015 829 A1 discloses an electrochemical energy storage cell having a current-interruption device for interrupting at least one electrical connection of the energy storage cell, which electrical connection is provided for operating the energy storage cell. Furthermore, the energy storage cell has a discharge device which allows complete or partial discharge of the energy storage cell when at least one electrical connection of the energy storage cell, which electrical connection is provided for operating the energy storage cell, is interrupted by the current-interruption device. This allows discharging of the energy storage cell and therefore safe transportation and safe storage of the energy storage cell while at the same time preventing further operation of the energy storage cell which may have been damaged by overcharging.

Document DE 10 2012 219 082 A1 discloses a safety apparatus for arrangement in a battery cell of a lithium-ion battery, comprising at least one planar metal conductor, in particular a metal printed circuit board or metal foil, to which an insulation layer is attached and which has a pole contact-making means for electrical connection to a pole of the battery cell, wherein the conductor has at least one heating resistor which is arranged on the insulation layer and has a first and a second contact-making means, wherein an electric current can be conducted through the heating resistor via the contact-making means.

### SUMMARY OF THE INVENTION

The procedure according to the invention having the characterizing features of the independent claims has the advantage over said prior art that the battery system comprises a tripping unit having an electrically conductive mechanical component for tripping the rapid-discharge unit. As a result, an electrical energy store of the battery system can advantageously be very rapidly discharged and the battery system is moved to a safe state.

The rapid-discharge unit advantageously comprises a conductor which is composed of an electrically conductive material, wherein the conductor is electrically connected to the first connection of the rapid-discharge unit and has an electrically conductive bimetallic strip at least in parts. As a result, an electrical connection between the conductor and the tripping unit can advantageously be established without additional electrical and/or electronic components.

The rapid-discharge unit comprises an electrically conductive contact-making means, wherein the contact-making means is electrically connected to the second connection of the rapid-discharge unit. An electrical connection between the conductor and the electrically conductive contact-making means is advantageously made possible by the electrically conductive contact-making means, as a result of which high electric currents can flow across the electrical connection.

The material of the contact-making means, of the bimetallic strip and/or of a coating of the bimetallic strip is selected such that an irreversible electrical connection between the contact-making means and the conductor is produced owing to a flow of current across an electrically conductive connection between the conductor and the contact-making means between the first pole and the second pole. As a result, an electrical energy store of the battery system is advantageously disconnected from an electrical circuit of the battery system and moved to a safe state.

The mechanical component of the tripping unit is reversibly or irreversibly deformable owing to a force which acts on the mechanical component, for example a pressure increase in the battery system. The electrically conductive connection between the conductor and the contact-making means of the rapid-discharge unit is disconnected owing to the reversible deformation after the electrical energy store returns to a normal operating state, as a result of which the electrical energy store is again available to the battery system. If the mechanical component is irreversibly deformed, the electrical energy store remains permanently disconnected from the battery system, as a result of which recommissioning of the electrical energy store is advantageously prevented.

The mechanical component of the tripping unit can be both designed as an additional component and/or realized by means of an existing component, for example an overpressure valve.

The mechanical component is electrically connected directly to the second pole by means of an electrically conductive housing of the electrical energy store and/or by means of an electrical connection. Lines are advantageously saved owing to an electrical connection by means of the electrically conductive housing. If the mechanical component is electrically connected directly to the second pole by means of an electrical connection, less stringent requirements are made in respect of electric-shock protection of the electrically conductive housing and simpler requirements are made in respect of the geometry of the electrically conductive housing since this does not have to be matched to a maximum flowing current.

The first connection of the rapid-discharge unit is electrically connected directly to the first pole by means of an electrical connection, and the second connection of the rapid-discharge unit is electrically connected to the second pole of the electrical energy store by means of the electrically conductive housing and/or is electrically connected directly to the second pole by means of an electrical connection. Insulation from a potential of the second pole is ensured owing to the direct electrical connection of the first connection of the rapid-discharge unit and the first pole. If the second connection of the rapid-discharge unit is connected to the second pole of the electrical energy store by means of the electrically conductive housing, no further lines are advantageously necessary. If the second connection of the rapid-discharge unit is connected directly to the second pole by means of an electrical connection, it is advantageously not necessary to adapt a geometry of the electrically conductive housing.

The mechanical component and/or the direct connection to the second pole has a greater resistance than the conductor, the contact-making means and/or the direct connection between the second connection of the rapid-discharge unit and the second pole. This advantageously has the result that a flowing short-circuit current between the first and the second pole of the electrical energy store flows across the conductor and the electrically conductive contact-making means.

The battery system according to the invention is advantageously used in a vehicle having at least one electrical energy store, as a result of which applicable safety standards are complied with a comparatively low level of expenditure.

The electrical energy store is advantageously a lithium-ion, a lithium-sulfur and/or a lithium-air battery. It is advantageous to rapidly move to a safe state particularly in these types of electrical energy stores due to possible chemical secondary reactions.

### DETAILED DESCRIPTION OF THE DRAWINGS

In the drawing:

FIG. 1 shows a first embodiment of the battery system according to the invention; and

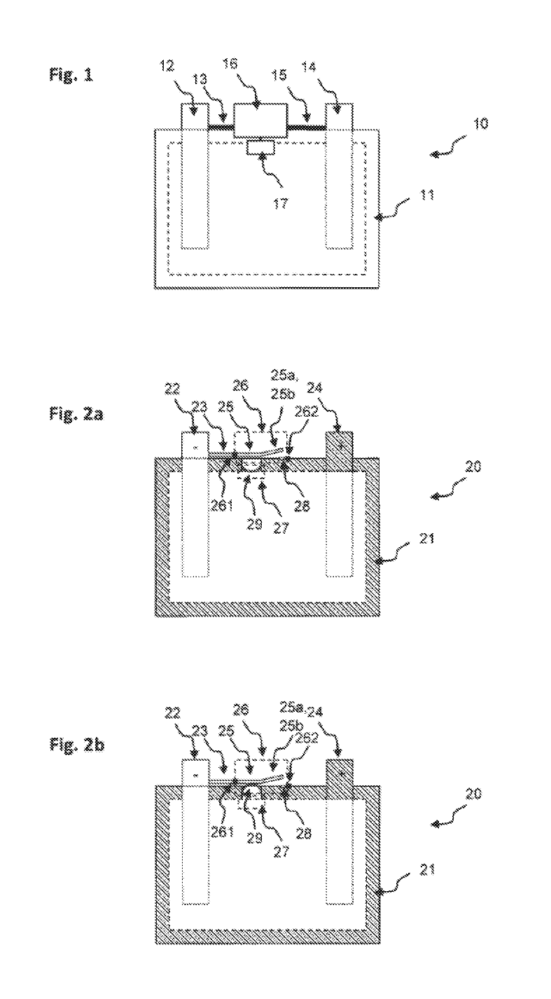

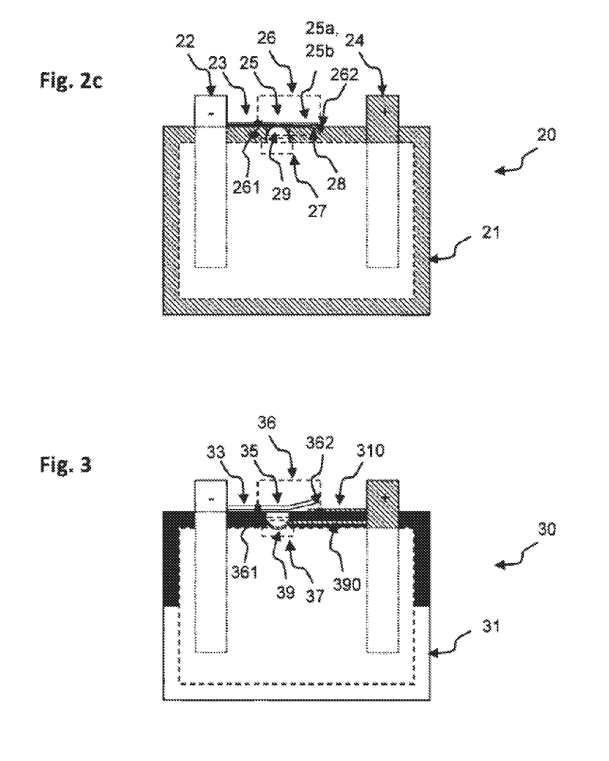

FIG. 2a shows a second embodiment of the battery system according to the invention; and

FIG. 2b shows the second embodiment of the battery system according to the invention in an abnormal operating state of the electrical energy store; and

FIG. 2c shows the second embodiment of the battery system according to the invention in the abnormal operating state of the electrical energy store with the rapid-discharge unit tripped; and

FIG. 3 shows a third embodiment of the battery system according to the invention during a normal operating state of an electrical energy store; and

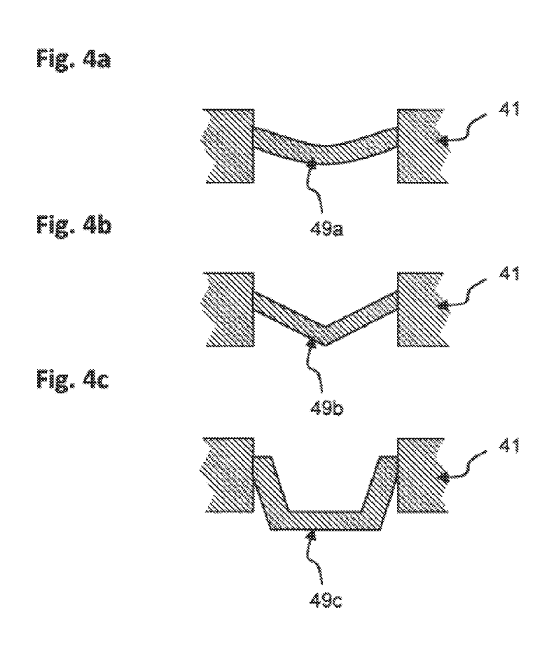

FIG. 4a shows a first embodiment of a mechanical component of a tripping unit of the battery system according to the invention; and

FIG. 4b shows a second embodiment of a mechanical component of a tripping unit of the battery system according to the invention; and

FIG. 4c shows a third embodiment of a mechanical component of a tripping unit of the battery system according to the invention.

Like reference symbols denote like apparatus components in all of the figures.

### DETAILED DESCRIPTION

FIG. 1 shows a first embodiment of the battery system 10 according to the invention having at least one electrical energy store, having a first pole 12 which is electrically connected to a first electrode of the electrical energy store, having a second pole 14 which is electrically connected to a second electrode of the electrical energy store, having a rapid-discharge unit 16 for electrically discharging the electrical energy store having a first connection which is electrically connected to the first pole, for example by means of an electrical connection 13, having a second connection which is electrically connected to the second pole, for example by means of an electrical connection 15, a tripping unit 17 for tripping the rapid-discharge unit 16, and also a housing 11 of the electrical energy store.

The tripping unit 17 can be both designed as an additional component or realized by means of an existing component, for example an overpressure valve in hard-case cells, as a result of which components are advantageously saved.

FIG. 2a shows a second embodiment of the battery system 20 according to the invention during a normal operating state of an electrical energy store. The electrical energy store comprises a first pole 22, for example a negative pole, which is electrically connected to a rapid-discharge unit 26 by means of an electrical connection 23 to a first connection 261, and also a second pole 24, for example a positive pole of the electrical energy store, which is electrically connected to the rapid-discharge unit 26 by means of an electrically conductive housing 21 of the electrical energy store by means of a second connection 262, and also a tripping unit 27 comprising a mechanical component 29 which is electrically conductive and is electrically connected to the second pole 24 by means of the electrically conductive housing 21 of the electrical energy store. The mechanical component 29 of the tripping unit 27 is reversibly or irreversibly deformable, for example owing to a force which acts on the mechanical component 29. The rapid-discharge unit 26 comprises a conductor 25 which is electrically connected to the electrical connection 23 by means of the first interface 261. The rapid-discharge unit 26 further comprises an electrically conductive contact-making means which is electrically connected to the second pole 24 of the energy store by means of the second connection 262. In a first embodiment, the conductor 25 comprises a bimetallic strip 25b at least in parts. In a second embodiment, the conductor 25 comprises a relay 25a.

There is no electrical connection between the mechanical component 29 of the tripping unit 27 and the conductor 25 of the rapid-discharge unit 26 during the normal operating state of the electrical energy store.

FIG. 2b shows the second embodiment of the battery system 20 according to the invention in an abnormal operating state of the electrical energy store. An abnormal operating state of the electrical energy store occurs, for example, when said electrical energy store is charged by an excessive charging current, this leading, for example, to an increase in pressure in the interior of the housing 21 of the electrical energy store. Owing to the increase in pressure, the mechanical component 29 of the tripping unit 27 is reversibly or irreversibly deformed when a prespecifiable pressure is exceeded, as a result of which an electrical connection between the mechanical component 29 of the tripping unit 27 and the conductor 25 of the rapid-discharge unit 26 is produced. Owing to this electrical connection, a current flows between the second pole 24 and the first pole 22 across the conductive housing 21, the mechanical component 29, the conductor 25 and the line 23.

FIG. 2c shows the second embodiment of the battery system 20 according to the invention in the abnormal operating state of the electrical energy store with the rapid-discharge unit 26 tripped.

In the first embodiment of the conductor 25, the bimetallic strip 25b is heated by the current flowing across the mechanical component 29 of the tripping unit 27 and the conductor 25, as a result of which said bimetallic strip deforms and establishes an electrical connection between the electrically conductive contact-making means 28 and the conductor 25. An irreversible electrical connection is produced by a selected material of the electrically conductive contact-making means and/or of the bimetallic strip 25b.

In the second embodiment of the conductor 25, the flowing current trips a relay 25a which establishes an electrical connection between the electrically conductive contact-making means 28 and the conductor 25.

Owing to the short circuit which is produced in this way between the first pole 22 and the second pole 24, the electrical energy store is discharged and disconnected from the charging current. As a result, the electrical energy store is moved to a safe state.

FIG. 3 shows a third embodiment of the battery system 30 according to the invention during a normal operating mode of an electrical energy store. A first connection 361 of a rapid-discharge unit 36 is connected to a first pole of the electrical energy store by means of an electrical connection, a second connection 362 of the rapid-discharge unit 36 is connected directly to a second pole of the electrical energy store by means of an electrical connection 310. In the embodiment shown, a housing 31 of the electrical energy store is not electrically conductive. A mechanical component 39 of a tripping unit 37 is connected directly to the second pole of the electrical energy store by means of an electrical connection 390. In an abnormal operating state of the electrical energy store, the mechanical component 39 of the tripping unit 37 is mechanically deformed, for example, by an increase in pressure in the interior of the housing 31 of the electrical energy store, as a result of which a current flows across an electrical connection between the first and second pole across the electrical connection 390, the mechanical component 39, the conductor 35 and the electrical connection 33. This electrical connection leads to tripping of the rapid-discharge unit 36, as a result of which a short circuit is produced between the first pole and the second pole by means of the electrical connection 310, the conductor 35 and the electrical connection 33 to the first pole. A resistance of the electrical connection 390 is greater in the shown embodiment than a resistance of the electrical connection 310.

FIG. 4a shows a first embodiment of a mechanical component 49a, of a tripping unit of the battery system according to the invention. The mechanical component 49a is electrically conductively connected to a housing 41 of an electrical energy store. The mechanical component 49a of the shown tripping unit is reversibly or irreversibly deformable. In the embodiment shown, the mechanical component 49a is designed as a diaphragm, wherein the material used is an electrically conductive metal or a metal alloy, a carrier material with an electrically conductive coating and/or an electrically conductive plastic. Owing to the selected shape of the mechanical component 49a, an increase in pressure in the interior of the electrical energy store equally acts on said mechanical component. A force with which the mechanical component 49a is deformed and which is to be exceeded is prespecified by the selected material of the mechanical component 49a.

FIG. 4b shows a second embodiment of a mechanical component 49b of a tripping unit of the battery system according to the invention. The mechanical component 49b is electrically connected to the housing 41 of the electrical energy store. A lower resistance between the mechanical component 49b and a conductor is achieved during deformation by the selected shape of the mechanical component 49b.

FIG. 4c shows a third embodiment of a mechanical component 49c of a tripping unit of the battery system according to the invention. A large-area connection between the mechanical component 49c and a conductor is achieved by the selected shape of the mechanical component 49c. Furthermore, movements of the housing 41 of the electrical energy store are compensated for, as a result of which damage to the mechanical component 49c is prevented.

What is claimed is:

1. A battery system (10, 20, 30) with overcharge and/or exhaustive-discharge protection, the battery system comprising at least one electrical energy store having a first pole (12, 22) which is electrically connected to a first electrode of the electrical energy store, having a second pole (14, 24) which is electrically connected to a second electrode of the electrical energy store, and having a rapid-discharge unit (16, 26, 36) for electrically discharging the electrical energy store, the rapid-discharge unit having a first connection (261, 361) which is electrically connected to the first pole (12, 22), and having a second connection (262, 362) which is electrically connected to the second pole (14, 24), wherein the battery system (10, 20, 30) comprises a tripping unit (17, 27, 37) having an electrically conductive mechanical component (29, 39, 49a, 49b, 49c) for tripping the rapid-discharge unit (16, 26, 36).

2. The battery system (10, 20, 30) according to claim 1, characterized in that the rapid-discharge unit (16, 26, 36) comprises a conductor (25, 35), wherein the conductor (25, 35) is electrically connected to the first connection (261, 361) of the rapid-discharge unit (16, 26, 36) and has an electrically conductive bimetallic strip (25b) and/or a relay (25a) at least in parts.

3. The battery system (10, 20, 30) according to claim 1, characterized in that the rapid-discharge unit (16, 26, 36) comprises an electrically conductive contact-making means (28), wherein the contact-making means (28) is electrically connected to the second connection (262, 362) of the rapid-discharge unit (16, 26, 36).

4. The battery system (10, 20, 30) according to claim 2, characterized in that the rapid-discharge unit (16, 26, 36) comprises an electrically conductive contact-making means (28), wherein the contact-making means (28) is electrically connected to the second connection (262, 362) of the rapid-discharge unit (16, 26, 36).

5. The battery system (10, 20, 30) according to claim 4, characterized in that the material of the contact-making means (28), of the bimetallic strip (25b), of the relay (25a) and/or of a coating of the bimetallic strip (25b) is such that a reversible or irreversible electrical connection between the contact-making means (28) and the conductor (25, 35) is produced owing to a flow of current across an electrically conductive connection between the conductor (25, 35) and the contact-making means (28) between the first pole (12, 22) and the second pole (14, 24).

6. The battery system (10, 20, 30) according to claim 1, characterized in that the mechanical component (29, 39, 49a, 49b, 49c) of the tripping unit (17, 27, 37) is reversibly or irreversibly deformable owing to a force which acts on the mechanical component (29, 39, 49a, 49b, 49c).

7. The battery system (10, 20, 30) according to claim 1, characterized in that the mechanical component (29, 39, 49a, 49b, 49c) is electrically connected directly (390) to the second pole (14, 24) by means of an electrically conductive housing (21, 41) of the electrical energy store and/or by means of an electrical connection.

8. The battery system (10, 20, 30) according to claim 1, characterized in that the first connection (261, 361) of the rapid-discharge unit (16, 26, 36) is electrically connected directly to the first pole (12, 22) by an electrical connection (13, 23, 33), and the second connection (262, 362) of the rapid-discharge unit (16, 26, 36) is electrically connected to the second pole (14, 24) of the electrical energy store by the electrically conductive housing (21, 41) and/or is electrically connected directly to the second pole (14, 24) by an electrical connection (310).

9. The battery system (10, 20, 30) according to claim 1, characterized in that the mechanical component (29, 39, 49a, 49b, 49c) and/or the direct connection (390) to the second pole (14, 24) has a greater resistance than the conductor (25, 35), the contact-making means (28) and/or the direct connection (310) between the second connection (262, 362) of the rapid-discharge unit (16, 26, 36) and the second pole (14, 24).

10. A vehicle comprising a battery system (10, 20, 30) according to claim 1 and at least one electrical energy store.

11. A vehicle according to claim 10, wherein the electrical energy store is a lithium-ion, a lithium-sulfur and/or a lithium-air battery.
